(19) United States
(12) Patent Application Publication
(10) Pub. No.: US 2016/0004736 A1
(43) Pub. Date: Jan. 7, 2016

(54) SIMILAR DATA SEARCH DEVICE,SIMILAR DATA SEARCH METHOD,AND COMPUTER-READABLE STORAGE MEDIUM

(71) Applicant: NEC CORPORATION, Minato-ku, Tokyo (JP)

(72) Inventors: Masaaki TSUCHIDA, Tokyo (JP); Kai ISHIKAWA, Tokyo (JP)

(73) Assignee: NEC Corporation, Minato-ku, Tokyo (JP)

(21) Appl. No.: 14/770,534

(22) PCT Filed: Mar. 5, 2014
(86) PCT No.: PCT/JP2014/055548

§ 371 Date: Aug. 26, 2015

(30) Foreign Application Priority Data
Mar. 7, 2013 (JP) 2013-045566

(51) Int. Cl. G06F 17/30

(52) U.S. Cl. CPC G06F 17/30321; G06F 17/30477

(57) ABSTRACT

A similar data search device includes: an inverted index generating unit which determines size ranges of sets of search targets for each of inverted indexes so that the number of sets of search targets is not smaller than a specified number and generates inverted indexes by dividing the sets of search targets according to the determined size ranges; an unnecessary inverted index identifying unit which determines, based on a size of a set of search conditions and a threshold value specified for a similarity between sets, a condition necessary for the similarity to be no smaller than the threshold value, and identifies, as an inverted index unnecessary for searches, any inverted index other than those inverted indexes containing a set whose minimum size value satisfies the condition; and a data search unit which conducts a search on a non-identified inverted index.

### TECHNICAL FIELD

The present invention relates to similar data search devices and, in particular, to a similar data search device and a similar data search method for carrying out a search based on a similarity between sets converted from character strings, and to a computer-readable recording medium that records a similar data search program for implementing such device and method.

### BACKGROUND ART

Similar data searching is the fundamental and important data processing with wide applicability to clustering, redundant data matching, character string soft matching, and the like. Specific methods for similar data searching may include mere calculation of similarities among all the target data pieces and doing a search based on the similarities, but this method needs a tremendously longer time for a greater amount of data.

For example, in order to search a database for every pair of data pieces having a similarity no smaller than a certain value, similarities have to be calculated (N (N−1)/2) times where N is the number of pieces of data. In other words, for example, assuming that one similarity calculation takes 0.001 milliseconds and the number of pieces of data N is 100,000, similarities have to be calculated about five billion times, which is equivalent to calculating for about 14 days.

Thus, NPTL 1 discloses a system for quickly retrieving every pair of data pieces having a similarity no smaller than a certain value to reduce the processing time. The system disclosed in NPTL 1 converts character strings to their feature sets, divides the sets according to their sizes where the size of a set is defined as the number of elements in a set, and generates every inverted index for the sets of the same size. Then, during a search, the system disclosed in NPTL 1 identifies a maximum value and a minimum value of the size for an inverted index to be searched based on the size of the inputted set and a similarity threshold value, and conducts a search on only the inverted indexes having a size falling within the identified range.

Specifically, Table 1 in NPTL 1 discloses that, assuming that the requested set for search is denoted by X, it is sufficient to search inverted indexes having a size equal to or greater than α|X| and equal to or less than |X|/α if the Jaccard coefficient (|X∩Y|/|X∪Y|) is not smaller than a threshold value cc. In this way, the system disclosed in NPTL 1 generates inverted indexes according to the size of a set and identifies which inverted index should be searched by using an upper limit and an lower limit of a size that are determined based on search conditions (search request). Consequently, unnecessary searches are omitted and thus a faster search is achieved.

### CITATION LIST

### Non Patent Literature

[NPTL 1] Naoaki Okazaki and Jun'ichi Tsujii. A Simple and Fast Algorithm for Approximate String Matching with Set Similarity. Journal of Natural Language Processing, Vol. 18, No. 2, pp. 89-117, 2011.

### SUMMARY OF INVENTION

### Technical Problem

However, the system disclosed in NPTL 1 is problematic in that the retrieval effectiveness is impaired when the search target data contains fewer sets of the same size.

This is because, due to the fact that every inverted index is created for sets of the same size, if the data of the same size exists in a smaller amount, a smaller number of sets can be searched from an inverted index, and thereby, the number of searches to inverted indexes should be increased to obtain the same result.

On average, the number of sets of the same size is inversely proportional to the number of searches to inverted indexes required to obtain the same result. For this reason, the retrieval effectiveness is impaired particularly by a high cost of searches to inverted indexes, such as the case where random access is made to an external storage device.

An object of the present invention is to provide a similar data search device, a similar data search method, and a computer-readable recording medium, solving the above problem and making it possible to suppress lowering the retrieval effectiveness caused by an increased number of searches in inverted indexes even when the search target data contains a small number of sets of the same size.

### Solution to Problem

To achieve the above-described object, a similar data search device according to an aspect of the present invention, which is a similar data search device for conducting searches by using sets as search target data and search condition data, includes:

an inverted index generating unit which, for generating inverted indexes used for a search, determines size ranges of sets of search targets for each of the inverted indexes to be generated so that at least a specified number of sets of search targets are included in each of the inverted indexes to be generated, and generates the inverted indexes by dividing the sets of search targets according to the determined size ranges;

an unnecessary inverted index identifying unit which determines, based on a size of a set of search conditions and a specified threshold value of a similarity between the set of search conditions and the set of search targets, a condition of a size of the set of search targets necessary for the similarity to be no smaller than the threshold value, and identifies, as an inverted index unnecessary for searches, from among the inverted indexes, any inverted index other than those inverted indexes which include a set whose minimum size value satisfies the condition; and

a data search unit which conducts a search by applying the set of search conditions to an inverted index other than the identified inverted index unnecessary for searches.

To achieve the above-described object, a similar data search method according to an aspect of the present invention, which is a similar data search method for conducting searches by using sets as search target data and search condition data, includes the steps of:

(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;

(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and

(c) conducting a search by applying the set of search conditions to an inverted index other than the inverted index unnecessary for searches as identified in the step (b).

Furthermore, to achieve the above-described object, a computer-readable recording medium according to an aspect of the present invention records a program for conducting a search with a computer by using sets as search target data and search condition data,

wherein the program includes instructions causing the computer to execute the steps of:

(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;

(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and

(c) conducting a search by applying the set of search conditions to an inverted index other than the inverted index unnecessary for searches as identified in the step (b).

### Advantageous Effects of Invention

As described above, according to the present invention, it is made possible to suppress lowering the retrieval effectiveness caused by an increased number of searches in inverted indexes even when the search target data contains a small number of sets of the same size.

### BRIEF DESCRIPTION OF DRAWINGS

FIG. 1 is a block diagram illustrating a configuration of a similar data search device according to a first exemplary embodiment of the present invention.

FIG. 2 is a flow diagram illustrating operations of the similar data search device according to the first exemplary embodiment of the present invention.

FIG. 3 is an explanatory diagram illustrating an example of Step A1, where the Jaccard coefficient is used as a similarity measure.

FIG. 4 is a diagram showing example mathematical expressions for obtaining a size range of a set.

FIG. 5 is a diagram showing example conditions for being equivalent to the case where a similarity is not smaller than a threshold value.

FIG. 6 is a block diagram illustrating a configuration of a similar data search device according to a second exemplary embodiment of the present invention.

FIG. 7 is a flow diagram illustrating operations of the similar data search device according to the second exemplary embodiment of the present invention.

FIG. 8 is a block diagram illustrating an example computer implementing the similar data search device according to either of the first and second exemplary embodiments of the present invention.

### DESCRIPTION OF EMBODIMENTS

### First Exemplary Embodiment

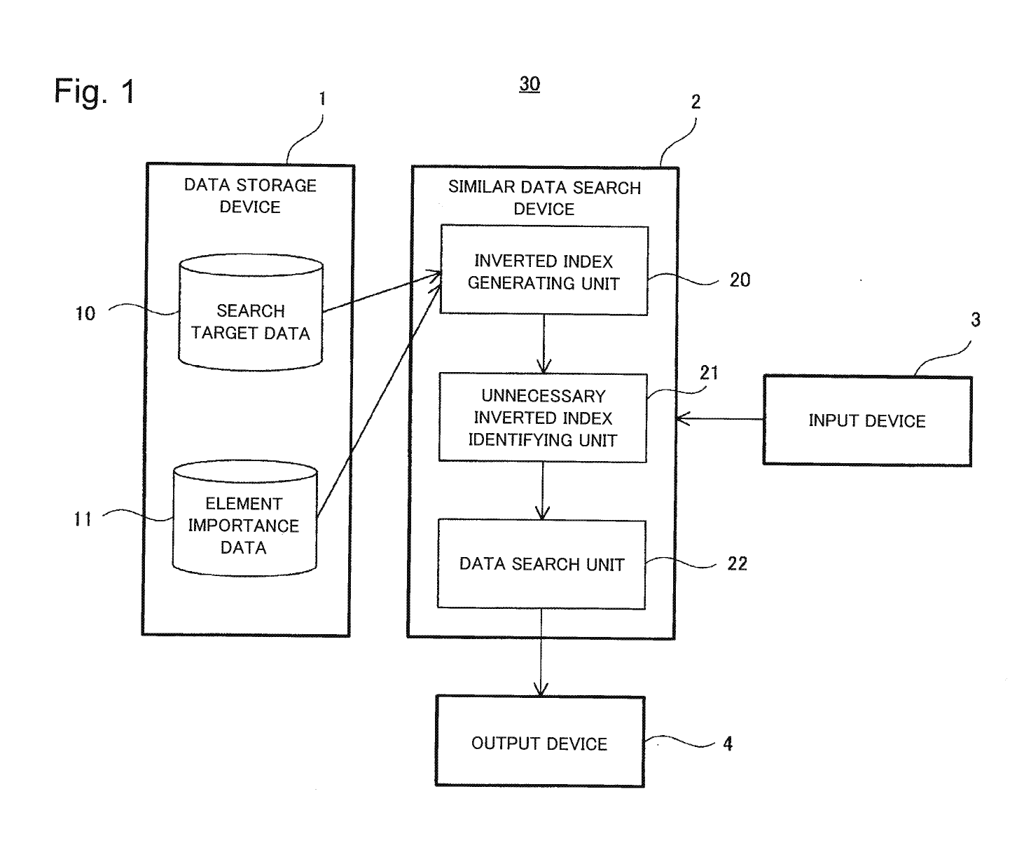

A similar data search device, a similar data search method, and a program for similar data searches according to a first exemplary embodiment of the present invention will now be described with reference to FIGS. 1 to 5.

### [Device Configuration]

To begin with, a configuration of the similar data search device according to the first exemplary embodiment is described with reference to FIG. 1. FIG. 1 is a block diagram illustrating the configuration of the similar data search device according to the first exemplary embodiment of the present invention.

The similar data search device 2 according to the first exemplary embodiment as illustrated in FIG. 1 is a device for conducting searches by using sets as the search target data and the search condition data. As illustrated in FIG. 1, the similar data search device 2 includes an inverted index generating unit 20, an unnecessary inverted index identifying unit 21, and a data search unit 22.

The inverted index generating unit 20 generates an inverted index to be used for a search. For this purpose, the inverted index generating unit 20 first determines size ranges of sets of search targets for each of inverted indexes to be generated so that the number of sets of search targets included in each of the inverted indexes to be generated is not smaller than a specified number. Then, the inverted index generating unit 20 generates inverted indexes by dividing the sets of search targets according to the determined size ranges.

The unnecessary inverted index identifying unit 21 first determines a condition of the size of a set of search targets required for a similarity to be no smaller than a threshold value, based on the size of the set of search conditions and on a threshold value specified for a similarity between sets of search conditions and search targets. Next, out of the inverted indexes, the unnecessary inverted index identifying unit 21 identifies, as an inverted index unnecessary for searches, any inverted index other than those inverted indexes containing a set whose minimum size value satisfies the condition.

The data search unit 22 distinguishes any inverted index from the inverted index(es) unnecessary for searches as identified by the unnecessary inverted index identifying unit 21, and then conducts a search by applying the set of search conditions to the distinguished inverted index.

Thus, in the present exemplary embodiment, a size range of sets is determined for each of inverted indexes containing the sets and, based on the size range, an inverted index unsuitable to be searched for a set of search conditions is identified. A search is then conducted on inverted indexes excluding the identified inverted index(es). As a result, even when the search target data contains a small number of sets of the same size, it is made possible to suppress lowering the retrieval effectiveness that would be caused by an increased number of searches in inverted indexes.

The configuration of the similar data search device 2 according to the first exemplary embodiment will now be described more specifically. As illustrated in FIG. 1, the similar data search device 2 is connected to a data storage device 1, an input device 3, and an output device 4, constituting a similar data search system 30 with these devices.

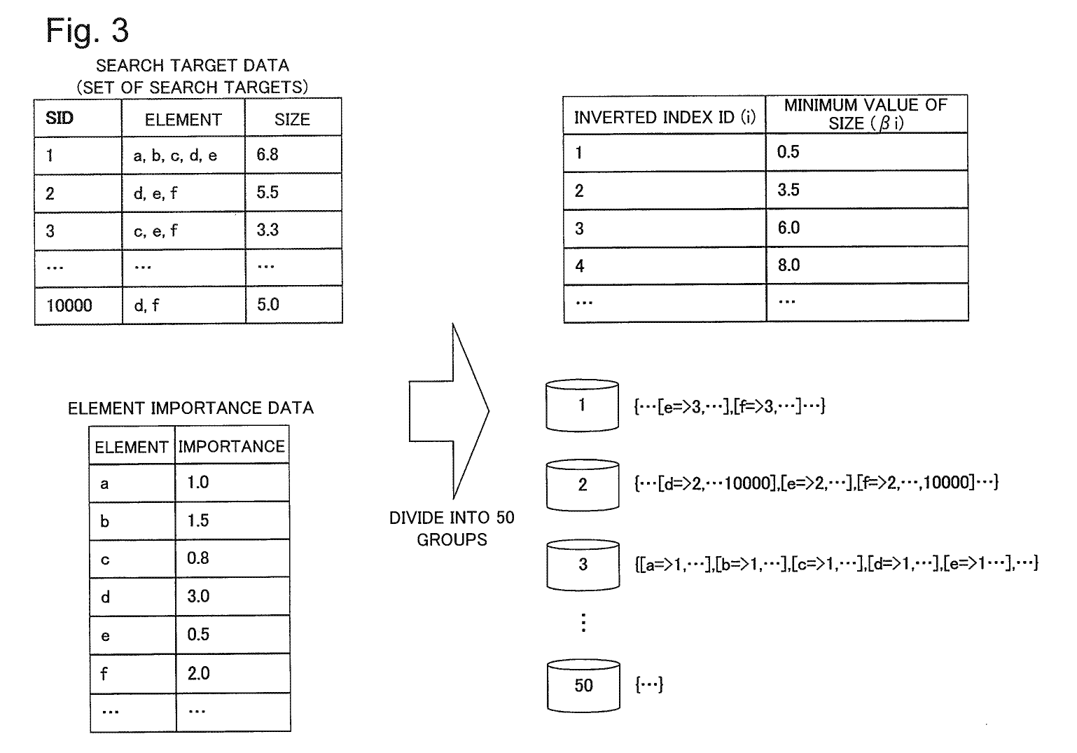

The data storage device 1 stores the search target data 10 comprised of sets of search targets as well as storing the element importance data 11 which is used for identifying importance levels that are pre-assigned to individual elements included in each set of search targets (refer to FIG. 3, which is described later).

The input device 3 is used for inputting data, such as a set of search conditions and a similarity threshold value, to the similar data search device 2. Examples of the input device 3 may include a keyboard and other input apparatuses, a terminal device connected to the similar data search device 2 via a network, and the like.

The output device 4 is a device to which search results are outputted. Examples of the output device 4 may include not only a display device and a printer but also a terminal device connected to the similar data search device 2 via a network. It should be noted that the input device 3 and the output device 4 may or may not be a single identical terminal device.

According to the first exemplary embodiment, a “set” may be comprised of one or more elements and each of the elements may optionally have a pre-assigned importance level as described above (refer to FIG. 3, which is described later). A set may optionally be comprised of character tri-grams as elements, as described in NPTL 1.

According to the first exemplary embodiment, a “similarity” between a set of search conditions and a set of search targets is calculated by, for example, solving a mathematical equation having D, Q, and w(.), where D is a set of search targets, Q is a set of search conditions (search request), and W(.) is a function which returns a weight of an importance level. For example, a similarity between sets is calculated by any one of: overlap (Q, D); overlap of Q from the viewpoint of D, overlap (D, Q); overlap of D from the viewpoint of Q, cosine (Q, D); cosine similarity, dice (Q, D); Dice's coefficient, and jaccard (Q, D); the Jaccard coefficient.

Specifically, a similarity between sets can be calculated by using any one of the following mathematical expressions 1 to 5. It should be noted, however, that a similarity according to the present exemplary embodiment is not limited to those obtained by solving the following expressions. In the present exemplary embodiment, any similarity measure may be applied without particular limitation as far as it defines a condition by means of the size of a set.

$$\begin{matrix}overlap ( Q , D ) = \frac{{\sum }_{e ∈ Q ⋂ D} w ( e )}{{\sum }_{e ∈ D} w ( e )} & [ Mathematical 1 ] \\ overlap ( D , Q ) = \frac{{\sum }_{e ∈ Q ⋂ D} w ( e )}{{\sum }_{e ∈ Q} w ( e )} & [ Mathematical 2 ] \\ cos ine ( Q , D ) = \frac{{\sum }_{e ∈ Q ⋂ D} w ( e )}{\sqrt{{\sum }_{e ∈ Q} {w ( e )}^{2}} \sqrt{{\sum }_{e ∈ D} {w ( e )}^{2}}} & [ Mathematical 3 ] \\ dice ( Q , D ) = \frac{2 {\sum }_{e ∈ Q ⋂ D} w ( e )}{{\sum }_{e ∈ Q} w ( e ) + {\sum }_{e ∈ D} w ( e )} & [ Mathematical 4 ] \\ jaccard ( Q , D ) = \frac{{\sum }_{e ∈ Q ⋂ D} w ( e )}{{\sum }_{e ∈ Q ⋃ D} w ( e )} & [ Mathematical 5 ]\end{matrix}$$

### [Device Operations]

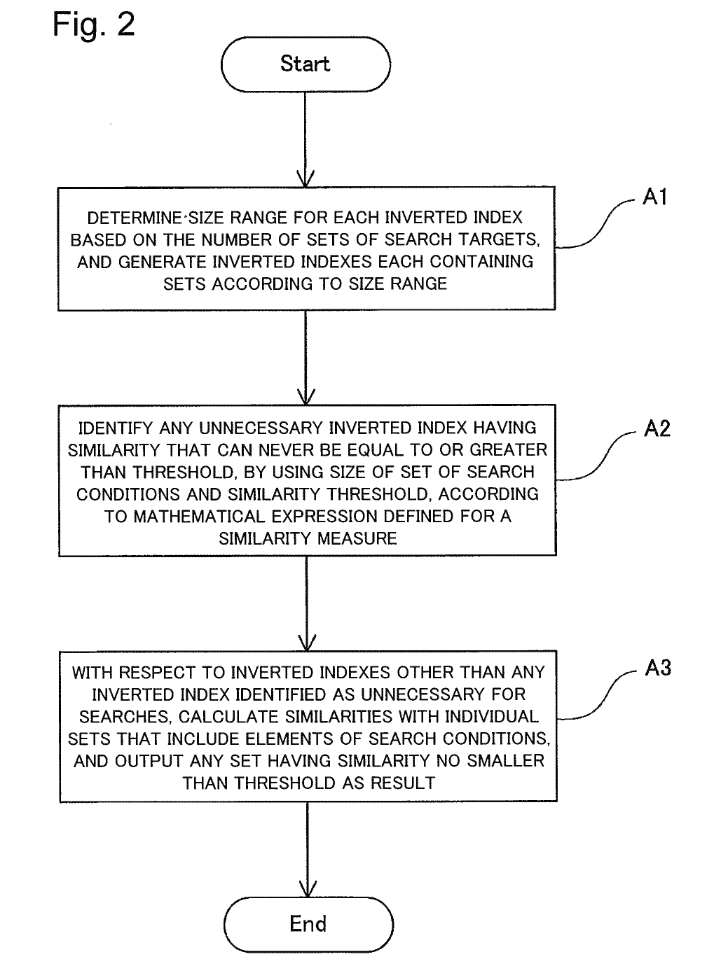

Now, operations of the similar data search device 2 according to the first exemplary embodiment of the present invention will be described with reference to FIGS. 2 to 5. FIG. 2 is a flow diagram illustrating operations of the similar data search device according to the first exemplary embodiment of the present invention. The following description takes FIG. 1 into consideration as may be appropriate. In the first exemplary embodiment, a similar data search method is implemented by operating the similar data search device 2. Hence, the following description about operations of the similar data search device takes the place of description concerning the similar data search method according to the first exemplary embodiment.

### [Step A1]

As shown in FIG. 2, the inverted index generating unit 20 starts with reading, from the data storage device 1, the search target data 10 comprised of sets of search targets and the element importance data 11 representing importance levels of individual elements of the sets. Then, the inverted index generating unit 20 calculates the size of each of the sets of search targets by using such data.

Next, the inverted index generating unit 20 determines a size range of a set of search targets so that the number of sets of search targets included in each of inverted indexes to be generated is equal to or greater than a specified number. The inverted index generating unit 20 then generates inverted indexes by dividing the sets of search targets according to the determined size ranges (Step A1).

If there exist a plurality of sets of search conditions, the inverted index generating unit 20 carries out a test search under each set of search conditions. This allows the inverted index generating unit 20 to determine a minimum number of sets of search targets included in each of inverted indexes to be generated so as to minimize the sum of search times required by the data search unit 22.

The following provides a detail description about how to calculate the size of a set. Assuming that X denotes the set whose size is to be calculated, the size of the set X is defined by the following mathematical expression 6 if the above-described two different overlaps, the Dice's coefficient, or the Jaccard coefficient is used as a similarity measure. If cosine similarity is used as a similarity measure, the size of the set X is defined by the mathematical expression 7 below.

$$\begin{matrix}{\sum }_{e ∈ X} w ( e ) & [ Mathematical 6 ] \\ \sqrt{{\sum }_{e ∈ X} {w ( e )}^{2}} & [ Mathematical 7 ]\end{matrix}$$

In addition, in Step A1, the inverted index generating unit 20 can calculate the size of each set of search targets by using importance levels that are pre-assigned to individual elements included in a set of search targets. Every element may have an importance level of 1; in this case the size of the set coincides with the number of elements in the set.

In contrast, if more specific importance levels are assigned to elements of a set, the number of sets of the same size is decreased. Thus, the above-described effect of the first exemplary embodiment can be provided to a greater extent. Accordingly, in the first exemplary embodiment, it is preferable that importance levels are assigned as specifically as possible.

In addition, in Step A1, the inverted index generating unit 20 can specify a threshold value for a size range so that every inverted index has at least a certain number of sets, and calculate a specified number by dividing the total number of sets of search targets by a specified value. Then, the inverted index generating unit 20 can determine the size range of sets of search targets for each of inverted indexes to be generated, based on the calculated specified number. In other words, the inverted index generating unit 20 may determine sizes by dividing the total number of sets of search targets by the specified number N to evenly divide the total sets into N groups.

The threshold for a size range and the specified number N can be determined by actually performing searches with a sample set of candidate search conditions. In this case, it is preferable to determine these values so that the calculation time can be minimized.

Furthermore, if it is possible to determine criteria for the number of sets that can be retrieved from each inverted index, inverted indexes can be generated by calculating the size of each set of search targets, sorting the sets in ascending order of size, and adding the sets to every inverted index starting from the smallest set in size until a predetermined condition is satisfied.

Now a specific example of Step A1 is described with reference to FIG. 3. FIG. 3 is an explanatory diagram illustrating an example of Step A1 using the Jaccard coefficient as a similarity measure. In the example in FIG. 3, the specified number N is set to 50.

As shown in FIG. 3, each set of search target data is assigned an identifier SID. The size of each set is calculated according to the above mathematical expression 6 because the Jaccard coefficient is used as a similarity measure. For example, the size of the set SID=1 is 6.8.

As the example in FIG. 3 contains 10,000 sets of search target data, it can be seen that, in order to divide the search target data into 50 groups according to the number of inverted indexes, these inverted indexes will be created so that about 200 sets belong to an inverted index.

Thus, the inverted index generating unit 20 sorts the individual sets of search targets in ascending order of size and adds the sets to each inverted index until the number of sets exceeds 200. If there exists another set of the same size as the 200th set, the inverted index generating unit 20 adds such another set to the inverted index where the 200th set is added. In this case, the inverted index generating unit 20 does not add any set to a new inverted index until it encounters a set of a different size.

Next, the inverted index generating unit 20 identifies a minimum size value β of a set that can be retrieved from each of the inverted indexes. The inverted index generating unit 20 then assigns IDs of inverted indexes to the individual identified values of β in their ascending order. Assuming that i denotes an ID and Di denotes a set included in an inverted index of each ID, the relationship between the size range for each inverted index and the size of a set is expressed by the following mathematical expression 8.

βᵢ≦|Dᵢ|<βᵢ₊₁ [Mathematical 8]

According to the above mathematical expression 8, when the inverted index ID=3 shown in FIG. 3 is used as search targets, any set whose size is equal to or greater than 6.0 and less than 8.0 can be retrieved. Hence, the inverted index of ID=3 includes the set of SID=1 whose size is 6.8.

### [Step A2]

After Step A1, the unnecessary inverted index identifying unit 21 determines a condition of the size of a set of search targets necessary for a similarity to be no smaller than a threshold value, according to a mathematical expression defined for each similarity measure, by using the size of a set of search conditions and the threshold value specified for a similarity.

Next, from among the inverted indexes, the unnecessary inverted index identifying unit 21 identifies any inverted index other than those inverted indexes containing a set whose minimum size value satisfies the condition, that is, any inverted index having a similarity that can never be equal or greater than the threshold value, as an inverted index unnecessary for searches (Step A2).

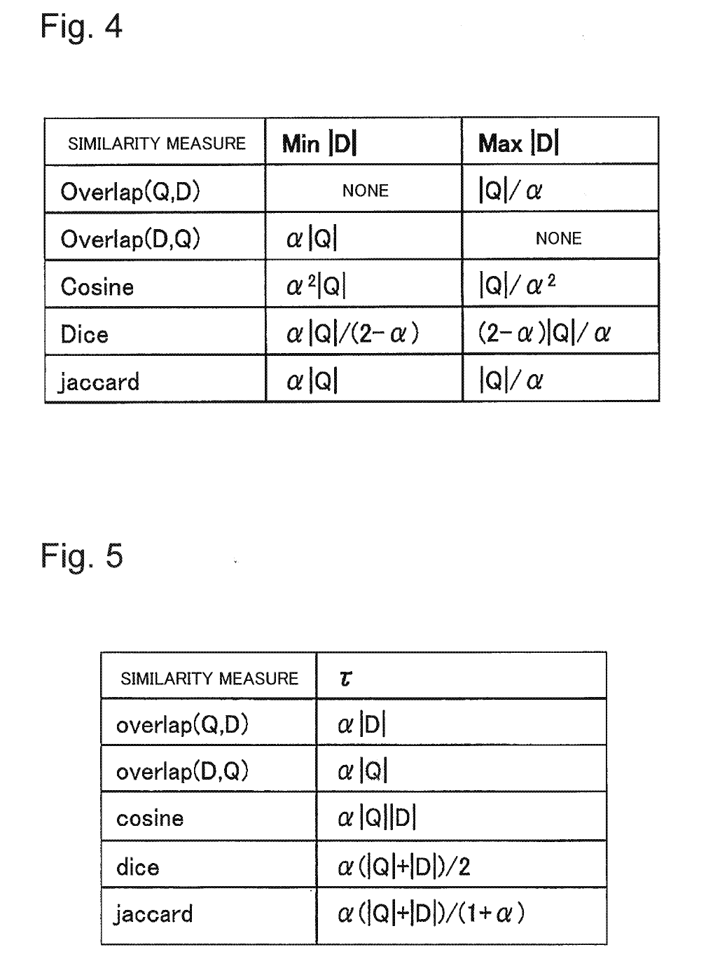

Now Step A2 will be described in more detail with reference to FIG. 4. FIG. 4 is a diagram showing example mathematical expressions for obtaining a size range of a set. That is, FIG. 4 shows mathematical expressions for determining a size range of a set that ensures a similarity is no smaller than α, with given Q and cc where Q is a set of search conditions and α is a threshold value.

Proofs of the mathematical expressions shown in FIG. 4 except overlaps are the same as those disclosed in NPTL 1 for the cases where no rounding up or down to an integer is involved, and thus description of the proofs is omitted in the present first exemplary embodiment. Proofs of overlap measures, Overlap (Q, D) and Overlap (D, Q), are as follows.

From the definition Overlap (Q, D) being no smaller than α is expressed by the following mathematical expression 9.

$$\frac{{\sum }_{e ∈ Q ⋂ D} w ( e )}{{\sum }_{e ∈ D} w ( e )} \geq α \qquad [ Mathematical 9 ]$$

The above mathematical expression 9 is transformed into the following mathematical expression 10. A maximum value of |D| in the mathematical expression 10 is expressed by the mathematical expression 11 below.

$$\begin{matrix}\frac{\vert Q \vert}{α} \geq \frac{{\sum }_{e ∈ Q} w ( e )}{α} \geq \frac{{\sum }_{e ∈ Q ⋂ D} w ( e )}{α} \geq {\sum }_{e ∈ D} w ( e ) = \vert D \vert & [ Mathematical 10 ] \\ \frac{\vert Q \vert}{α} \geq \vert D \vert & [ Mathematical 11 ]\end{matrix}$$

Similarly, Overlap (D, Q) is expressed by the following mathematical expression 12 from the definition.

$$\frac{{\sum }_{e ∈ Q ⋂ D} w ( e )}{{\sum }_{e ∈ Q} w ( e )} \geq α \qquad [ Mathematical 12 ]$$

The above mathematical expression 12 is transformed into the following mathematical expression 13. A minimum value of |D| in the mathematical expression 13 is expressed by the mathematical expression 14 below.

$$\begin{matrix}\vert D \vert = {\sum }_{e ∈ D} w ( e ) \geq {\sum }_{e ∈ Q ⋂ D} w ( e ) \geq α {\sum }_{e ∈ Q} w ( e ) = α \vert Q \vert & [ Mathematical 13 ] \\ \vert D \vert \geq α \vert Q \vert & [ Mathematical 14 ]\end{matrix}$$

For example, when Q, |Q|, and α are given where Q is a set of search conditions, |Q| is the size of the set, and α is a threshold, to ensure that the similarity is not smaller than the threshold cc, the size of the set of search targets D needs to be equal to or greater than α|Q| and equal to or less than |Q|/α, because the present example uses the Jaccard coefficient. Specifically, if the set of search conditions Q are comprised of elements e and f and the threshold α is 0.6, then |Q| is 2.2 and thus the minimum and maximum values of the size are 1.32 (=2.2×0.6) and 3.667 (≈2.2/0.6), respectively.

Now, referring to lower limits β for inverted indexes listed in FIG. 3, the size of a set contained in either of the inverted index ID 1 and ID 2 is represented by β1 (=0.5)≦|D|<β3 (=6.0), which already includes the minimum and maximum values. This indicates that ID 3 and subsequent inverted indexes are unnecessary for searches. In this way, the unnecessary inverted index identifying unit 21 identifies any inverted index unnecessary for searches by using a minimum size value for each of inverted indexes.

### [Step A3]

Finally, with respect to the inverted indexes other than any identified inverted index unnecessary for searches, the data search unit 22 calculates a similarity between the set of search conditions and the individual sets that include applicable elements, and then outputs, as a search result, any set whose similarity is not smaller than the threshold value, to the output device 4 (Step A3).

For example, given that the above-described set of search conditions Q includes elements e and f, the data search unit 22 retrieves, for example, SID=3 from the inverted index whose ID is 1 shown in FIG. 3. The data search unit 22 also retrieves, for example, SID=10000 from the inverted index whose ID is 2. Then, the data search unit 22 can calculate a similarity between the individual sets as obtained above and the set of search conditions to output, as a search result, the data whose similarity is actually not smaller than the threshold cc.

In Step A3, the data search unit 22 may also handle searches as the τ-overlap problem, similarly to NPTL 1. That is, the data search unit 22 identifies any element common to those elements in the set of search conditions for each of the sets included in an inverted index (hereinafter denoted as a “non-identified inverted index”) other than any identified inverted index, and then calculates the sum of importance levels of the identified elements. If the calculated sum satisfies the condition for being equivalent to the case where a similarity is not smaller than a threshold α, the data search unit 22 presents, as a search result, the set included in the non-identified inverted index subjected to the calculation.

Specifically, when |D|, |Q|, and α are given where |D| is the size of a set of search targets, |Q| is the size of a set of search conditions, and α is a threshold value, the case where the sum of importance levels of elements common to sets Q and D is equal to or greater than τ, which is calculated according to any of the expressions listed in FIG. 5, is deemed to be equivalent to a similarity between the sets D and Q being no smaller than α. In this case, calculation of the size |D| of a set of search targets need only be performed once at the time of generating an inverted index; moreover, calculation of the size |Q| of a set of search conditions need only be performed once as well, which eliminates the need for calculating similarities every time, thus increasing efficiency of calculation. FIG. 5 is a diagram showing example conditions for being equivalent to the case where a similarity is not smaller than a threshold value.

Furthermore, in the present exemplary embodiment, the data search unit 22 can check every element in a set of search conditions, on a one-by-one basis, against each of the sets included in a non-identified inverted index in sequence. In this case, if the sum of importance levels of the unchecked elements becomes neither equal to nor greater than τ (that is, less than τ), the data search unit 22 carries out the checking by using the unchecked elements only against the sets that have already been checked by that time, from among the sets included in an inverted index. The data search unit 22 then calculates the sum of importance levels of the common elements with regard to only the sets that have been checked by that time.

In other words, the first exemplary embodiment can optionally utilize the property as disclosed in NPTL 1: when the sum of unsearched elements in a set of search conditions Q becomes less than τ, the sum of importance levels of common elements in both a set of any SID that is subsequently to be first retrieved and the set Q becomes to be equal to or greater than τ.

Specifically, the data search unit 22 considers that a minimum size value β of a set included in each inverted index is |D| and calculates τ so as to satisfy a minimum requirement with respect to a set in the inverted index. Once the sum of unsearched elements in the set of search conditions Q is less than τ, the data search unit 22, presuming that the only SIDs that have already been searched by that time are candidates, checks for any remaining unsearched element by performing a binary search on a list of elements obtained from the inverted index for each SID. While a linear search has computational complexity of O(n), a binary search for checking existence has computational complexity of O(log n), where n is the number of sets that contain elements, which means the efficiency can be improved.

It should be noted that after the switching to the binary search, the size of each set SID is used for τ on each set. Additionally, to efficiently determine that the sum of the unsearched elements in the set of search conditions Q is less than τ, the data search unit 22 preferably searches (checks) elements in descending order of importance level.

### (Effect of First Exemplary Embodiment)

As described above, in the first exemplary embodiment, the inverted index generating unit 20 generates each inverted index so that the number of sets of search targets is not reduced. The unnecessary inverted index identifying unit 21 then identifies, based on search conditions and a minimum size value of a set in each of inverted indexes, any unnecessary inverted index for finding a set having a similarity no smaller than a threshold value. Next, the data search unit 22 performs a search on inverted indexes other than the unnecessary inverted index(es). Consequently, according to the first exemplary embodiment, it is made possible to find all the sets having similarities no smaller than a threshold value efficiently due to the fact that the number of references to inverted indexes is decreased on the whole, even when there are a small number of sets of the same size as that of the set of search conditions.

### [Program]

A program according to the present exemplary embodiment may be any program causing a computer to execute Steps A1 to A3 shown in FIG. 2. The similar data search device 30 and the similar data search method according to the present exemplary embodiment can be implemented by installing the program on a computer and executing it. In this case, a central processing unit (CPU) in the computer acts as the inverted index generating unit 20, the unnecessary inverted index identifying unit 21, and the data search unit 22 to handle processes.

### Second Exemplary Embodiment

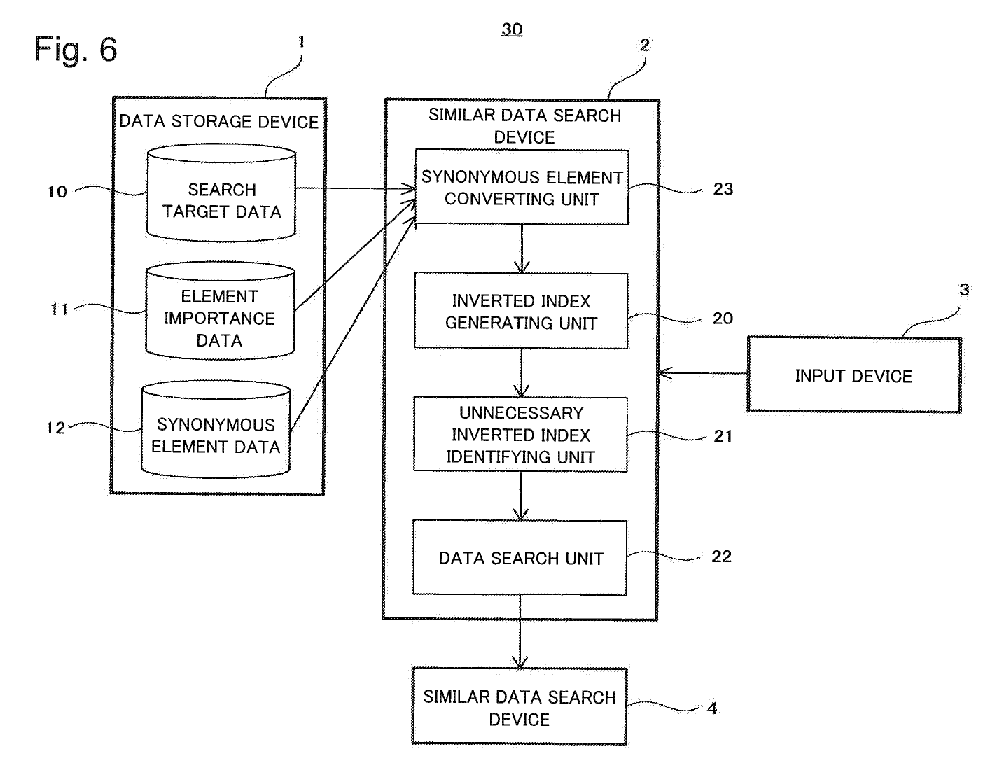

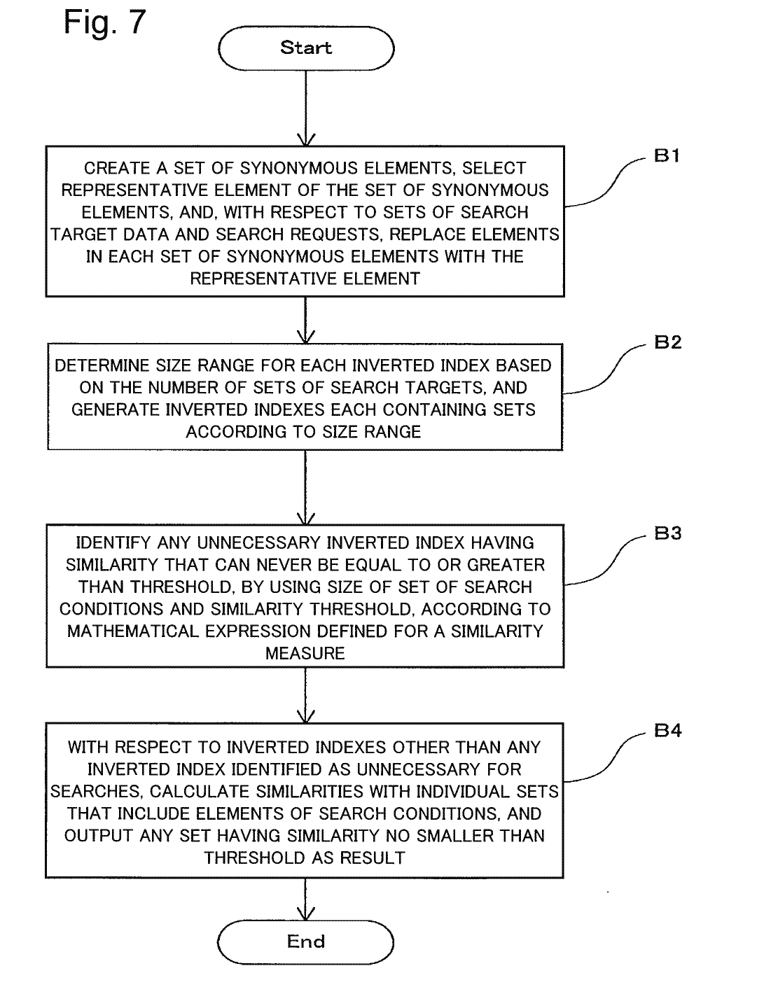

Now a similar data search device, a similar data search method, and a program for similar data searches according to a second exemplary embodiment of the present invention will be described below with reference to FIGS. 6 and 7.

### [Device Configuration]

To begin with, a configuration of the similar data search device according to the second exemplary embodiment is described with reference to FIG. 6. FIG. 6 is a block diagram illustrating the configuration of the similar data search device according to the second exemplary embodiment of the present invention.

As shown in FIG. 6, the similar data search device 5 according to the second exemplary embodiment is different from the similar data search device 2 of the first exemplary embodiment illustrated in FIG. 1 in that: first, the similar data search device 5 of the second exemplary embodiment includes a synonymous element converting unit 23, in addition to an inverted index generating unit 20, an unnecessary inverted index identifying unit 21, and a data search unit 22. The synonymous element converting unit 23 converts, among elements included in a set of search targets or search conditions, any element belonging to a set of determined synonymous elements into a representative element of the synonymous elements.

Additionally, in the second exemplary embodiment, the similar data search device 5 utilizes synonymous element data 12, in addition to search target data 10 and element importance data 11. The synonymous element data 12 is the data for defining apparently synonymous elements, being stored in the data storage device 1 along with the search target data 10 and the element importance data 11.

Specifically, the synonymous element converting unit 23 reads the search target data 10, the element importance data 11, and the synonymous element data 12 to generate a set of synonymous elements. Then, with respect to each of the sets of search targets and search conditions, the synonymous element converting unit 23 replaces elements belonging to a set of synonymous elements with the representative element of the set of synonymous elements and outputs any set that has been subjected to the replacement to the inverted index generating unit 20.

### [Operation of the Device]

Now, operations of the similar data search device 5 according to the second exemplary embodiment of the present invention will be described with reference to FIG. 7. FIG. 7 is a flow diagram illustrating operations of the similar data search device according to the second exemplary embodiment of the present invention. The following description takes FIG. 6 into consideration as may be appropriate. In the second exemplary embodiment, a similar data search method is implemented by operating the similar data search device 5. Hence, the following description about operations of the similar data search device takes the place of description concerning the similar data search method according to the second exemplary embodiment.

### [Step B1]

As shown in FIG. 7, the synonymous element converting unit 23 starts with reading the synonymous element data and the element importance data to create a set of synonymous elements, with respect to each set of search targets and each set of search conditions.

Next, the synonymous element converting unit 23 selects a representative element of each set of synonymous elements and replaces the elements belonging to a set of synonymous elements with the representative element, with respect to each set of search targets and each set of search conditions (Step B1).

In Step B1, a set of synonymous elements is created by drawing an undirected edge between nodes, which are regarded as a pair of elements apparently being synonymous, and by interpreting the nodes all along link components outgoing from an element as synonymous elements.

The representative element may be selected from an element of the highest importance, an element of the lowest importance, an element of the median importance, a first element in the case of totally ordered elements, and the like. It should be noted that no particular limitation is imposed on the method of selecting a representative element.

### [Steps B2 to B4]

Next, Steps B2 to B4 are carried out through the use of a set of search targets where elements have been converted to a representative element as well as a set of search conditions where elements have been converted to a representative element. Steps B2 to B4 are identical to Steps A1 to A3 in FIG. 2, respectively, and thus they are carried out as illustrated in FIG. 2 and finally a search result is outputted.

### (Effect of Second Exemplary Embodiment)

As described above, in the second exemplary embodiment, the synonymous element converting unit 23 replaces synonymous elements with a representative element prior to the search processing. Similar data searches are thus conducted by equating different but synonymous elements with one element, achieving searches of higher accuracy.

### (Computer)

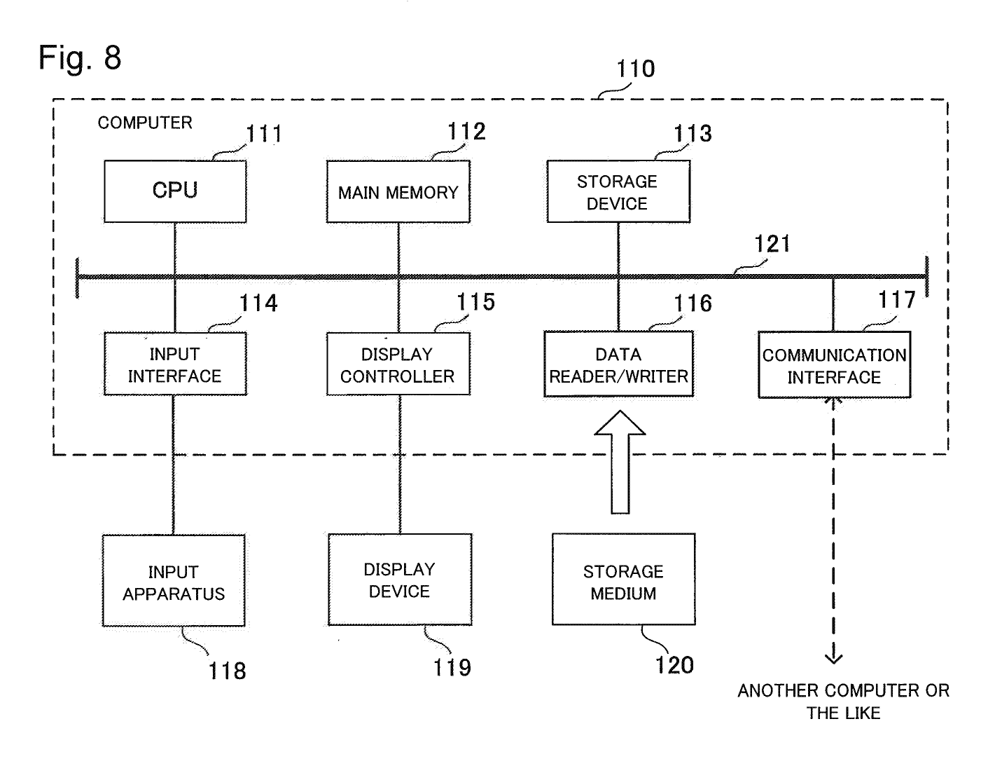

The following describes a computer which implements the similar data search device according to either of the first and second exemplary embodiments by executing a program, referring to FIG. 8. FIG. 8 is a block diagram illustrating an example computer implementing the similar data search device according to either of the first and second exemplary embodiments of the present invention.

As illustrated in FIG. 8, a computer 110 includes a CPU 111, main memory 112, a storage device 113, an input interface 114, a display controller 115, a data reader/writer 116, and a communication interface 117. These individual units are connected to a bus 121 so that data can be communicated with one another via the bus.

The CPU 111 performs various computations by deploying programs (code) according to an exemplar embodiment of the present invention stored in the storage device 113 into the main memory 112 and by executing these programs in a predetermined order. The main memory 112 is typically a volatile storage device such as dynamic random access memory (DRAM). The programs according to the present exemplary embodiment are provided in the state where they are contained in a computer-readable recording medium 120. The programs according to the present exemplary embodiment may optionally be distributed on the Internet which is connected via the communication interface 117.

Specific examples of the storage device 113 may include a semiconductor storage device, such as flash memory, in addition to a hard disk drive. The input interface 114 provides an interface for data transmission between the CPU 111 and an input apparatus 118 such as a keyboard or mouse. The display controller 115, which is connected to a display device 119, controls display on the display device 119.

The data reader/writer 116 provides an interface for data transmission between the CPU 111 and the recording medium 120, reads programs out of the recording medium 120, and writes results of processing carried out in the computer 110 into the recording medium 120. The communication interface 117 provides an interface for data transmission between the CPU 111 and another computer.

Specific examples of the recording medium 120 may include a general-purpose semiconductor storage device such as CompactFlash® (CF) and Secure Digital (SD), a magnetic storage medium such as a flexible disk, and an optical storage medium such as Compact Disk Read-Only Memory (CD-ROM).

The whole or part of the above-described exemplary embodiments can be described as, but is not limited to, the following Supplementary Notes 1 to 30.

### (Supplementary Note 1)

A similar data search device for conducting a search by using sets as search target data and search condition data, the device comprising:

an inverted index generating unit which, for generating inverted indexes used for a search, determines size ranges of sets of search targets for each of the inverted indexes to be generated so that at least a specified number of sets of search targets are included in each of the inverted indexes to be generated, and generates the inverted indexes by dividing the sets of search targets according to the determined size ranges;

an unnecessary inverted index identifying unit which determines, based on a size of a set of search conditions and a specified threshold value of a similarity between the set of search conditions and the set of search targets, a condition of a size of the set of search targets necessary for the similarity to be no smaller than the threshold value, and identifies, as an inverted index unnecessary for searches, from among the inverted indexes, any inverted index other than those inverted indexes which include a set whose minimum size value satisfies the condition; and

a data search unit which conducts a search by applying the set of search conditions to an inverted index other than the identified inverted index unnecessary for searches.

### (Supplementary Note 2)

The similar data search device according to Supplementary Note 1, wherein the inverted index generating unit calculates the specified number by dividing a total number of sets of the search targets by a specified value and determines, based on the specified number as calculated, the size ranges of sets of the search targets for each of the inverted indexes to be generated.

### (Supplementary Note 3)

The similar data search device according to Supplementary Note 1 or 2, wherein the inverted index generating unit determines, if a plurality of sets of the search conditions exist, a minimum number of sets of search targets included in each of the inverted indexes to be generated so as to minimize the sum of search times required for a search conducted by the data search unit.

### (Supplementary Note 4)

The similar data search device according to any one of Supplementary Notes 1 to 3,

wherein the unnecessary inverted index identifying unit calculates the condition by using a mathematical expression and the threshold value, the mathematical expression being defined by any one of an overlap of a set of the search conditions with a set of the search targets, an overlap of a set of the search targets with a set of the search conditions, the Jaccard coefficient, Dice's coefficient, and cosine similarity.

### (Supplementary Note 5)

The similar data search device according to any one of Supplementary Notes 1 to 4,

wherein the data search unit identifies, from among sets that are included in an inverted index other than the identified inverted index unnecessary for searches, any set that includes an element of a set of the search conditions, and presents, as a search result, the identified set if the similarity between the identified set and the set of the search conditions is not smaller than the threshold value.

### (Supplementary Note 6)

The similar data search device according to any one of Supplementary Notes 1 to 5,

wherein the inverted index generating unit further calculates the size of each set of the search targets by using importance levels that are pre-assigned to individual elements included in a set of the search targets.

### (Supplementary Note 7)

The similar data search device according to Supplementary Note 6,

wherein the similarity is calculated by using a mathematical expression defined by any one of an overlap of a set of the search conditions with a set of the search targets, an overlap of a set of the search targets with a set of the search conditions, the Jaccard coefficient, Dice's coefficient, and cosine similarity,

and wherein the data search unit identifies, for each set included in an inverted index other than the identified inverted index unnecessary for searches, any elements common to elements of a set of the search conditions, calculates the sum of the importance levels of the identified elements, and, if the calculated sum satisfies a condition for being equivalent to a case where the similarity is not smaller than the threshold value, presents the set subjected to calculation as a search result.

### (Supplementary Note 8)

The similar data search device according to Supplementary Note 7,

wherein the data search unit

checks every element in a set of the search conditions, on a one-by-one basis, against each set included in an inverted index other than the identified inverted index unnecessary for searches in sequence;

if the sum of importance levels of unchecked elements no longer satisfies the condition, carries out checking by using the unchecked elements only against sets that have already been checked by that time from among the sets included in the inverted index; and

calculates the sum of the importance levels of the common elements with regard to only the sets that have been checked by that time.

### (Supplementary Note 9)

The similar data search device according to Supplementary Note 8, wherein the data search unit checks elements of a set of the search conditions in descending order of importance level.

### (Supplementary Note 10)

The similar data search device according to any one of Supplementary Notes 1 to 9, further comprising:

a synonymous element converting unit which converts, among elements included in a set of the search targets and a set of the search conditions, any element belonging to a set of determined synonymous elements into a representative element of the synonymous elements.

### (Supplementary Note 11)

A method for conducting a search by using sets as search target data and search condition data, the method comprising the steps of:

(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;

(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and

(c) conducting a search by applying the set of search conditions to an inverted index other than the inverted index unnecessary for searches as identified in the step (b).

### (Supplementary Note 12)

The similar data search method according to Supplementary Note 11, wherein, in the step (a), the specified number is calculated by dividing a total number of sets of the search targets by a specified value and the size ranges of sets of the search targets are determined for each of the inverted indexes to be generated, based on the specified number as calculated.

### (Supplementary Note 13)

The similar data search method according to Supplementary Note 11 or 12, wherein, in the step (a), if a plurality of sets of the search conditions exist, a minimum number of sets of search targets included in each of the inverted indexes to be generated is determined so as to minimize the sum of search times required for a search in the step (c).

### (Supplementary Note 14)

The similar data search method according to any one of Supplementary Notes 11 to 13,

wherein, in the step (b), the condition is calculated by using a mathematical expression and the threshold value, the mathematical expression being defined by any one of an overlap of a set of the search conditions with a set of the search targets, an overlap of a set of the search targets with a set of the search conditions, the Jaccard coefficient, Dice's coefficient, and cosine similarity.

### (Supplementary Note 15)

The similar data search method according to any one of Supplementary Notes 11 to 14,

wherein, in the step (c), from among sets that are included in an inverted index other than the inverted index unnecessary for searches as identified in the step (b), any set that includes an element of a set of the search conditions is identified, and the identified set is presented as a search result if the similarity between the identified set and the set of the search conditions is not smaller than the threshold value.

### (Supplementary Note 16)

The similar data search method according to any one of Supplementary Notes 11 to 15,

wherein, additionally in the step (a), the size of each set of the search targets is calculated by using importance levels that are pre-assigned to individual elements included in a set of the search targets.

### (Supplementary Note 17)

The similar data search method according to Supplementary Note 16,

wherein the similarity is calculated by using a mathematical expression defined by any one of an overlap of a set of the search conditions with a set of the search targets, an overlap of a set of the search targets with a set of the search conditions, the Jaccard coefficient, Dice's coefficient, and cosine similarity,

and wherein, in the step (c), for each set included in an inverted index other than the inverted index unnecessary for searches as identified in the step (b), any elements common to elements of a set of the search conditions are identified, and the sum of the importance levels of the identified elements is calculated, and, if the calculated sum satisfies a condition for being equivalent to a case where the similarity is not smaller than the threshold value, the set subjected to calculation is presented as a search result.

### (Supplementary Note 18)

The similar data search method according to Supplementary Note 17,

wherein, in the step (c), every element in a set of the search conditions is checked, on a one-by-one basis, against each set included in an inverted index other than the identified inverted index unnecessary for searches in sequence;

if the sum of importance levels of unchecked elements no longer satisfies the condition, checking is carried out by using the unchecked elements only against sets that have already been checked by that time from among the sets included in the inverted index; and

the sum of the importance levels of the common elements is calculated with regard to only the sets that have been checked by that time.

### (Supplementary Note 19)

The similar data search method according to Supplementary Note 18, wherein, in the step (c), elements of a set of the search conditions are checked in descending order of importance level.

### (Supplementary Note 20)

The similar data search method according to any one of Supplementary Notes 11 to 19, further comprising the step of:

(d) converting, among elements included in a set of the search targets and a set of the search conditions, any element belonging to a set of determined synonymous elements into a representative element of the synonymous elements.

### (Supplementary Note 21)

A computer-readable recording medium which records a program for conducting a search with a computer by using sets as search target data and search condition data,

wherein the program comprises instructions causing the computer to execute the steps of:

(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;

(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and

(c) conducting a search by applying the set of search conditions to an inverted index other than the inverted index unnecessary for searches as identified in the step (b).

### (Supplementary Note 22)

The computer-readable recording medium according to Supplementary Note 21, wherein, in the step (a), the specified number is calculated by dividing a total number of sets of the search targets by a specified value and the size ranges of sets of the search targets are determined for each of the inverted indexes to be generated, based on the specified number as calculated.

### (Supplementary Note 23)

The computer-readable recording medium according to Supplementary Note 21 or 22, wherein, in the step (a), if a plurality of sets of the search conditions exist, a minimum number of sets of search targets included in each of the inverted indexes to be generated is determined so as to minimize the sum of search times required for a search in the step (c).

### (Supplementary Note 24)

The computer-readable recording medium according to any one of Supplementary Notes 21 to 23,

wherein, in the step (b), the condition is calculated by using a mathematical expression and the threshold value, the mathematical expression being defined by any one of an overlap of a set of the search conditions with a set of the search targets, an overlap of a set of the search targets with a set of the search conditions, the Jaccard coefficient, Dice's coefficient, and cosine similarity.

### (Supplementary Note 25)

The computer-readable recording medium according to any one of Supplementary Notes 21 to 24,

wherein, in the step (c), from among sets that are included in an inverted index other than the inverted index unnecessary for searches as identified in the step (b), any set that includes an element of a set of the search conditions is identified, and the identified set is presented as a search result if the similarity between the identified set and the set of the search conditions is not smaller than the threshold value.

### (Supplementary Note 26)

The computer-readable recording medium according to any one of Supplementary Notes 21 to 25,

wherein, additionally in the step (a), the size of each set of the search targets is calculated by using importance levels that are pre-assigned to individual elements included in a set of the search targets.

### (Supplementary Note 27)

The computer-readable recording medium according to Supplementary Notes 26,

wherein the similarity is calculated by using a mathematical expression defined by any one of an overlap of a set of the search conditions with a set of the search targets, an overlap of a set of the search targets with a set of the search conditions, the Jaccard coefficient, Dice's coefficient, and cosine similarity,

and wherein, in the step (c), for each set included in an inverted index other than the inverted index unnecessary for searches as identified in the step (b), any elements common to elements of a set of the search conditions are identified, and the sum of the importance levels of the identified elements is calculated, and, if the calculated sum satisfies a condition for being equivalent to a case where the similarity is not smaller than the threshold value, the set subjected to calculation is presented as a search result.

### (Supplementary Note 28)

The computer-readable recording medium according to Supplementary Notes 27,

wherein, in the step (c), every element in a set of the search conditions is checked, on a one-by-one basis, against each set included in an inverted index other than the identified inverted index unnecessary for searches in sequence;

if the sum of importance levels of unchecked elements no longer satisfies the condition, checking is carried out by using the unchecked elements only against sets that have already been checked by that time from among the sets included in the inverted index; and

the sum of the importance levels of the common elements is calculated with regard to only the sets that have been checked by that time.

### (Supplementary Note 29)

The computer-readable recording medium according to Supplementary Note 28, wherein, in the step (c), elements of a set of the search conditions are checked in descending order of importance level.

### (Supplementary Note 30)

The computer-readable recording medium according to any one of Supplementary Notes 21 to 29,

wherein the program further comprises an instruction causing the computer to execute the step of:

(d) converting, among elements included in a set of the search targets and a set of the search conditions, any element belonging to a set of determined synonymous elements into a representative element of the synonymous elements.

The present invention has been described with reference to exemplary embodiments, but the invention is not limited to these embodiments. Various modification of the present invention that could be understood by those skilled in the art may be made to configurations or details of the invention within the scope of the invention.

The present application claims priority based on Japanese Patent Application No. 2013-045566 filed on Mar. 7, 2013, the entire disclosure of which is herein incorporated.

### Advantageous Effects of Invention

As described above, according to the present invention, it is made possible to suppress lowering the retrieval effectiveness caused by an increased number of searches in inverted indexes even when the search target data contains a small number of sets of the same size. The present invention is particularly useful for data clustering systems which handle matching redundant data to delete redundant data and grouping similar data, systems which handle dictionary soft matching through soft matching with dictionary entries, and the like.

### REFERENCE SIGNS LIST

1 Data storage device
2 Similar data search device (first exemplary embodiment)
3 Input device
4 Output device
5 Similar data search device (second exemplary embodiment)
10 Search target data
11 Element importance data
12 Synonymous element data
20 Inverted index generating unit
21 Unnecessary inverted index for search identifying unit
22 Data search unit
23 Synonymous element converting unit
30 Similar data search system
110 Computer
111 CPU
112 Main memory
113 Storage device
114 Input interface
115 Display controller
116 Data reader/writer
117 Communication interface
118 Input apparatus
119 Display device
120 Recording medium
121 Bus

What is claimed is:

1. A similar data search device for conducting a search by using sets as search target data and search condition data, the device comprising:
an inverted index generating unit configured to, for generating inverted indexes used for a search, determines size ranges of sets of search targets for each of the inverted indexes to be generated so that at least a specified number of sets of search targets are included in each of the inverted indexes to be generated, and generates the inverted indexes by dividing the sets of search targets according to the determined size ranges;
an unnecessary inverted index identifying unit configured to determine, based on a size of a set of search conditions and a specified threshold value of a similarity between the set of search conditions and the set of search targets, a condition of a size of the set of search targets necessary for the similarity to be no smaller than the threshold value, and identify, as an inverted index unnecessary for searches, from among the inverted indexes, any inverted index other than those inverted indexes which include a set whose minimum size value satisfies the condition; and
a data search unit configured to conducts a search by applying the set of search conditions to an inverted index other than the identified inverted index unnecessary for searches.

2. The similar data search device according to claim 1, wherein the inverted index generating unit calculates a specified number by dividing a total number of sets of the search targets by a specified value and determines, based on the specified number as calculated, the size ranges of sets of the search targets for each of the inverted indexes to be generated.

3. The similar data search device according to claim 1, wherein the inverted index generating unit determines, if a plurality of sets of the search conditions exist, a minimum number of sets of search targets included in each of the inverted indexes to be generated so as to minimize the sum of search times required for a search conducted by the data search unit.

4. The similar data search device according to claim 1,
wherein the unnecessary inverted index identifying unit calculates the condition by using a mathematical expression and the threshold value, the mathematical expression being defined by any one of an overlap of a set of the search conditions with a set of the search targets, an overlap of a set of the search targets with a set of the search conditions, the Jaccard coefficient, Dice's coefficient, and cosine similarity.

5. The similar data search device according to claim 1,
wherein the data search unit identifies, from among sets that are included in an inverted index other than the identified inverted index unnecessary for searches, any set that includes an element of a set of the search conditions, and presents, as a search result, the identified set if the similarity between the identified set and the set of the search conditions is not smaller than the threshold value.

6. The similar data search device according to claim 1,
wherein the inverted index generating unit further calculates the size of each set of the search targets by using importance levels that are pre-assigned to individual elements included in a set of the search targets.

7. The similar data search device according to claim 1,
wherein the similarity is calculated by using a mathematical expression defined by any one of an overlap of a set of the search conditions with a set of the search targets, an overlap of a set of the search targets with a set of the search conditions, the Jaccard coefficient, Dice's coefficient, and cosine similarity,
and wherein the data search unit
checks every element in a set of the search conditions, on a one-by-one basis, against each set included in an inverted index other than the identified inverted index unnecessary for searches in sequence in descending order of the importance level;
if the sum of importance levels of unchecked elements no longer satisfies the condition, carries out checking by using the unchecked elements only against sets that have already been checked by that time from among the sets included in the inverted index;
calculates the sum of the importance levels of the elements common to elements of a set of the search conditions with regard to only the sets that have been checked by that time; and
if the calculated sum satisfies a condition for being equivalent to a case where the similarity is not smaller than the threshold value, presents the set subjected to calculation as a search result.

8. The similar data search device according to claim 1, further comprising:
a synonymous element converting unit which converts, among elements included in a set of the search targets and a set of the search conditions, any element belonging to a set of determined synonymous elements into a representative element of the synonymous elements.

9. A method for conducting a search by using sets as search target data and search condition data, the method comprising:
(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;
(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and
(c) conducting a search by applying the set of search conditions to an inverted index other than the inverted index unnecessary for searches as identified in the step (b).

10. A non-transitory computer-readable recording medium which records a program for conducting a search with a computer by using sets as search target data and search condition data, wherein the program causing the computer to execute processing for:
(a) for generating inverted indexes used for a search, determining size ranges of sets of search targets for each of inverted indexes to be generated so that at least a specified number of sets of search targets are included in each of the inverted index to be generated, and generating the inverted indexes by dividing the sets of search targets according to the determined size ranges;
(b) determining, based on a size of a set of search conditions and a specified threshold value of a similarity between the set of search conditions and the set of search targets, a condition of a size of the set of search targets necessary for the similarity to be no smaller than the threshold value, and identifying, as an inverted index unnecessary for searches, from among the inverted indexes, any inverted index other than those inverted indexes that include a set whose minimum size value satisfies the condition; and
(c) conducting a search by applying the set of search conditions to an inverted index other than the inverted index unnecessary for searches as identified in the step (b).
